(19) United States
(12) Patent Application Publication
(10) Pub. No.: US 2018/0364809 A1
(43) Pub. Date: Dec. 20, 2018

(54) PERFORM FUNCTION DURING INTERACTIVE SESSION

(71) Applicant: Lenovo (Singapore) Pte. Ltd., Singapore (SG)

(72) Inventors: John Weldon Nicholson, Cary, NC (US); Daryl Cromer, Cary, NC (US)

(21) Appl. No.: 15/628,022

(22) Filed: Jun. 20, 2017

(51) Int. Cl. G06F 3/01; G06F 3/16; G06F 3/0488

(52) U.S. Cl. CPC G06F 3/017; G06F 3/0488; G06F 3/167

(57) ABSTRACT

One embodiment provides a method, including: engaging, at an information handling device, in an interactive session with a user; receiving, at the information handling device, user command input comprising one or more of: voice input and gesture input; determining, using a processor, whether the user command input is associated with at least one function, wherein the at least one function is based on a characteristic associated with the user command input; and performing, during the interactive session, the at least one function. Other aspects are described and claimed.

### BACKGROUND

Information handling devices (“devices”), for example smart phones, tablet devices, smart speakers, laptop and personal computers, and the like, may be capable of receiving user command inputs and providing outputs responsive to the inputs. A user may interact with a device by providing inputs to and receiving outputs from a digital assistant disposed on the device. Generally, responsive to receiving a user query or a user command, the digital assistant will provide a corresponding output until the output response is complete.

### BRIEF SUMMARY

In summary, one aspect provides a method, comprising: engaging, at an information handling device, in an interactive session with a user; receiving, at the information handling device, user command input comprising one or more of: voice input and gesture input; determining, using a processor, whether the user command input is associated with at least one function, wherein the at least one function is based on a characteristic associated with the user command input; and performing, during the interactive session, the at least one function.

Another aspect provides an information handling device, comprising: a processor; a memory device that stores instructions executable by the processor to: engage in an interactive session with a user; receive user command input comprising one or more of: voice input and gesture input; determine whether the user command input is associated with at least one function, wherein the at least one function is based on a characteristic associated with the user command input; and perform, during the interactive session, the at least one function.

A further aspect provides a product, comprising: a storage device that stores code, the code being executable by a processor and comprising: code that engages in an interactive session with a user; code that receives user command input comprising one or more of: voice input and gesture input; code that determines whether the user command input is associated with at least one function, wherein the at least one function is based on a characteristic associated with the user command input; and code that performs, during the interactive session, the at least one function.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of performing at least one function based on a characteristic associated with user command input during an interactive session.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Users frequently utilize devices to execute a variety of different commands or queries. One method of interacting with a device is to use digital assistant software employed on the device (e.g., Siri® for Apple®, Cortana® for Windows®, Alexa® for Amazon®, etc.). Digital assistants are able to provide outputs (e.g., audible outputs, visual outputs, etc.) that are responsive to a variety of different types of user inputs (e.g., voice inputs, etc.).

Conventionally, when prompted to provide output, digital assistants continue to provide output until the response is completed. For example, responsive to receiving a user query to provide directions to a location, a conventional digital assistant may continue to provide directional output regardless of whether the user wishes to temporarily interrupt or stop the output (e.g., by providing additional user input during provision of the output such as “hold on”, “stop”, etc.). Existing solutions provide limited means to interrupt the output or to alter output feedback. Additionally, although there are gestures for media playback today, these gestures are pre-defined (e.g., a particular gesture leads to a predefined command, etc.) and do not consider the context in which these gestures are applied nor do they apply to conversational agents such as digital assistants.

Accordingly, an embodiment provides a method for performing at least one function based on a characteristic associated with user command input provided during an interactive session. In an embodiment, the user command input may be provided during provision of output and may serve to adjust an output setting associated with the output. In an embodiment, an interactive session may be engaged. During the interactive session, an embodiment may receive user command input comprising either voice input or gesture input. An embodiment may then determine whether the user command input is associated with at least one function and perform the corresponding function during the interactive session. In an embodiment, the at least one function may be based on a characteristic associated with the user command input. Such a method may enable users to interact with a digital assistant in a more natural way.

The illustrated example embodiments will be best understood by reference to the figures. The following description is intended only by way of example, and simply illustrates certain example embodiments.

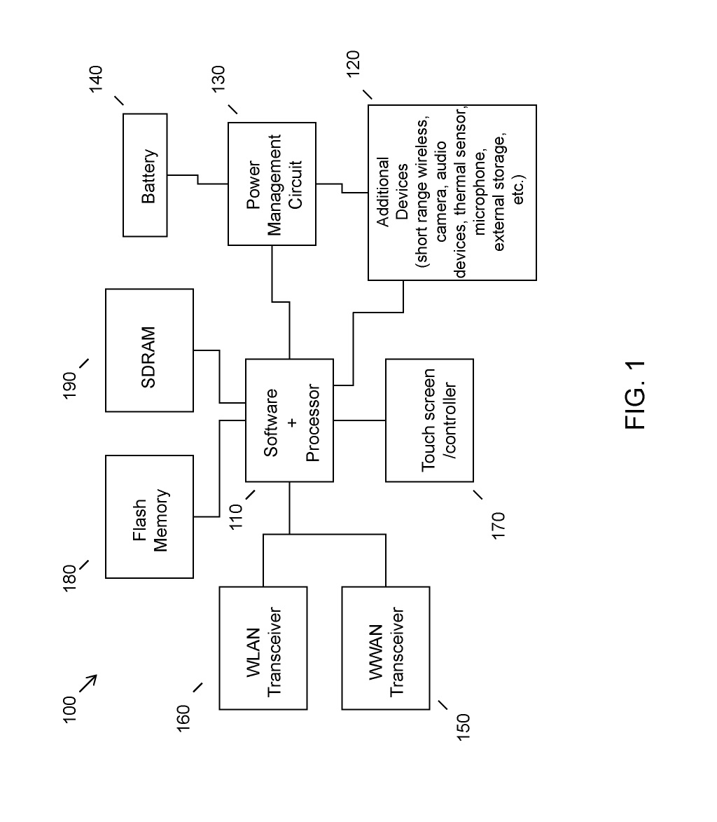

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, a thermal sensor, etc. System 100 often includes a touch screen 170 for data input and display/rendering. System 100 also typically includes various memory devices, for example flash memory 180 and SDRAM 190.

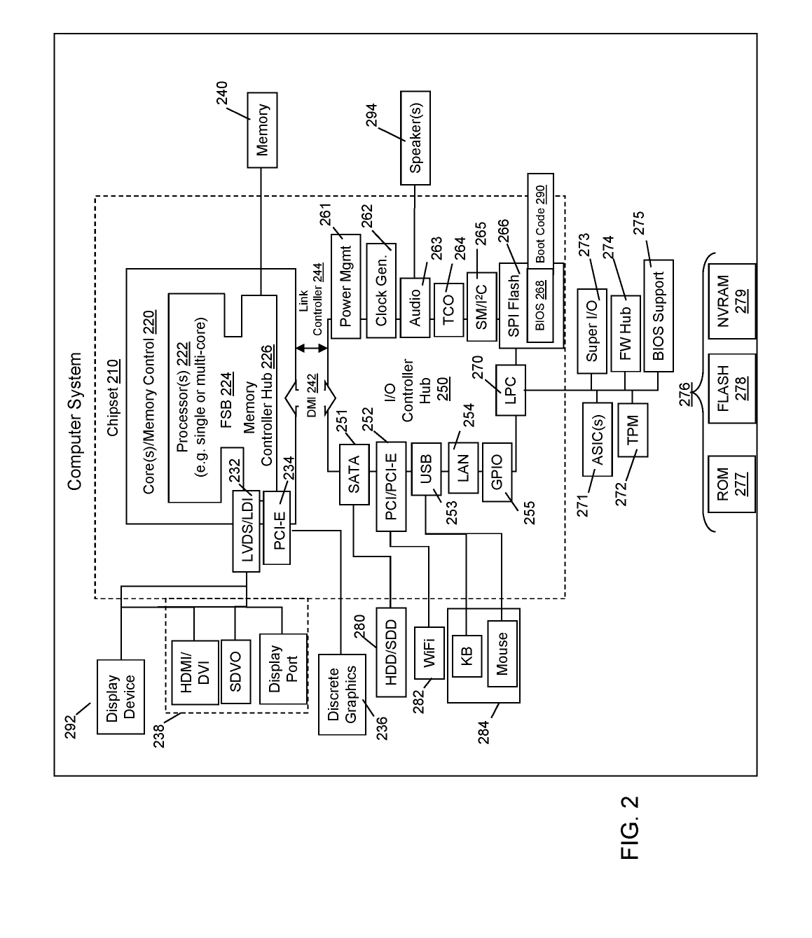

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, smart speakers, personal computer devices generally, and/or electronic devices which may include digital assistants that a user may interact with and that may perform various functions responsive to receiving user input. For example, the circuitry outlined in FIG. 1 may be implemented in a tablet or smart phone embodiment, whereas the circuitry outlined in FIG. 2 may be implemented in a personal computer embodiment.

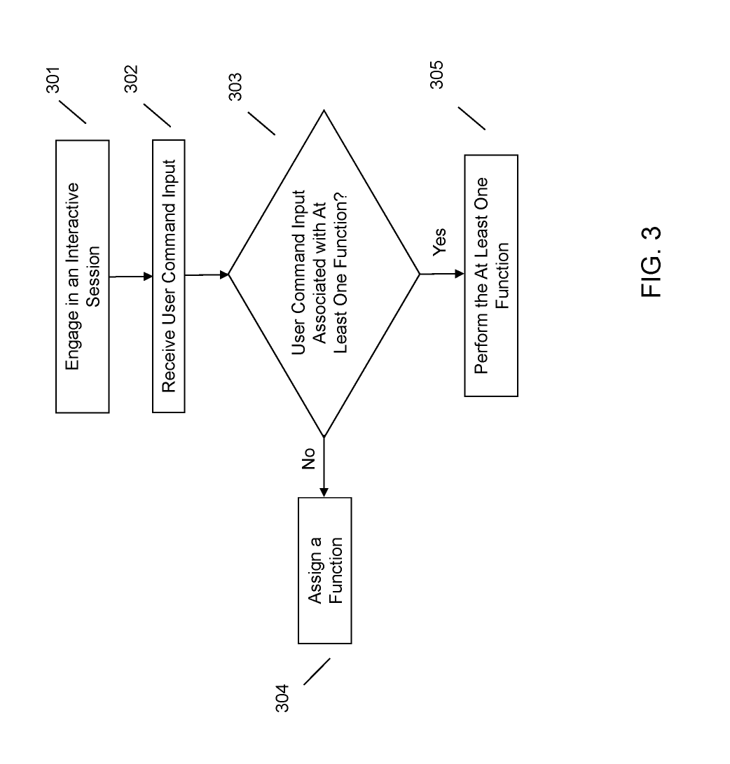

Referring now to FIG. 3, an embodiment may perform at least one function based on a characteristic associated with user command input received during an interactive session. At 301, an embodiment may engage or be engaged in an interactive session with a user. Engaging in the interactive session may include starting an interactive session, processing user input, providing output to user input, waiting for additional user input, and the like. In other words, engagement in an interactive session may include any point during a conversational session or exchange with a digital assistant or agent.

Starting an interactive session may be started by receiving an indication to begin the interactive session. In an embodiment, the indication may be a wakeup action provided by a user (e.g., one or more wakeup words, a depression of a button for a predetermined length of time, a selection of a digital assistant icon, etc.). In an embodiment, the wakeup action may be provided prior to or in conjunction with the user input. For example, a user may provide the vocal input, “Ok Surlexana, what is the fastest route from home to work?” In this scenario, “Ok Surlexana” is the wakeup word and upon identification of the wakeup word an embodiment may prime the system to listen for additional user input. Responsive to the identification of the wakeup action, an embodiment may initiate an interactive session.

The system may also be programmed to not require a wakeup action. For example, the system may simply “listen” to the user and determine when the user is providing input directed at the system. The interactive session may then be initiated when the system determines that the user input is directed to the system. As discussed above and in more detail below, in one embodiment, the interactive session may comprise at least one user input, which may include a user command or query, and at least one user output.

At 302, an embodiment may receive user command input from at least one user. The user command input may be received at any time during the interactive session. For example, the user command input may be received while the digital assistant is processing user input, providing output responsive to the user input, and the like. The input may be received at an input device (e.g., physical keyboard, on-screen keyboard, audio capture device, image capture device, video capture device, etc.) and may be provided by any known method of providing input to an electronic device (e.g., gesture input, touch input, text input, voice input, etc.). For simplicity purposes, the majority of the discussion herein will involve voice input that may be received at an input device (e.g., a microphone, a speech capture device, etc.) operatively coupled to a speech recognition device and gesture input that may be received at an input device (e.g., a camera, a gesture capture device, etc.) operatively coupled to a gesture recognition device. However, it should be understood that generally any form of user input may be utilized.

In an embodiment, the input device may be an input device integral to the speech recognition device or the gesture recognition device. For example, a smart phone may be disposed with a microphone or camera capable of receiving voice input data and gesture input data accordingly. Alternatively, the input device may be disposed on another device and may transmit received voice input data or gesture input data to the speech recognition device or gesture recognition device accordingly. For example, voice input may be received at a smart speaker that may subsequently transmit the voice data to another device (e.g., to a user's smartphone for processing, etc.). Voice input data and gesture input data may be communicated from other sources to the speech recognition device and gesture recognition device via a wireless connection (e.g., using a BLUETOOTH connection, near field communication (NFC), wireless connection techniques, etc.), a wired connection (e.g., the device is coupled to another device or source, etc.), through a connected data storage system (e.g., via cloud storage, remote storage, local storage, network storage, etc.), and the like.

In an embodiment, the input devices may be configured to continuously receive voice and gesture input data by maintaining the input devices in an active state. The input devices may, for example, continuously detect voice and gesture input data even when other sensors (e.g., cameras, light sensors, speakers, other microphones, etc.) associated with the speech recognition device are inactive. Alternatively, the input devices may remain in an active state for a predetermined amount of time (e.g., 30 minutes, 1 hour, 2 hours, etc.). Subsequent to not receiving any voice or gesture input data during this predetermined time window, an embodiment may switch the input devices to a power off state. The predetermined time window may be preconfigured by a manufacturer or, alternatively, may be configured and set by one or more users.

In an embodiment, the voice and gesture input may be virtually any type of voice and gesture input that dictates a function of how output is provided to a user. For example, regarding voice input, the voice input may be a user command such as “hold on”, “get to the point”, “slow down”, and the like. Regarding gesture input, the gesture input may be a user extending their hand toward the camera with the palm facing the camera to command the digital assistant to stop providing output, a user rotating their finger in a circle to command the digital assistant to increase output speed, and the like. In an embodiment, the command input may be received during provision of output by the device. For example, responsive to receiving a user query to provide directions to a location, a digital assistant may begin to provide corresponding directions. During provision of these directions, a user may provide voice or gesture input to the device (e.g., voice input such as “hold on a second” or a corresponding gesture input such as holding a hand in the air, etc.).

At 303, an embodiment may determine whether the user command input is associated with at least one function. In this context, the at least one function may refer to a function associated with how output is performed or how output is provided to a user. In an embodiment, the at least one function may be based on a characteristic associated with the user command input.

In an embodiment, the characteristic associated with the user command input may comprise a context associated with the user command input. In an embodiment, a corresponding output function associated with the user command input may be different based upon the determined context. In an embodiment, the context may be identified from the user input (e.g., a user command to “order me a pizza” may be associated with a pizza ordering context, etc.), an application a user is interacting with (e.g., a virtual book, a video-streaming application, etc.), a user's accessible context data (e.g., calendar entries, saved notes, social media entries, etc.) and the like. In an embodiment, the same command input may correspond to a different output function based upon the context. For example, when a user is ordering a pizza, they may progress through the pizza ordering process by providing the input “next” or performing a swipe gesture with their hand. Alternatively, when a user is interacting with a virtual book, the user-provided input “next” or the swipe hand gesture may be associated with a function that turns the page of the virtual book.

In an embodiment, the characteristic associated with the user command input may comprise a user providing the command input. In an embodiment, multiple users may access and use a single device. In such a situation, an embodiment may identify a user prior to accessing command input data associated with that particular user. For example, multiple users may have the ability to access a device (e.g., a laptop computer, a desktop computer, etc.) by logging into a user profile. Each user profile may contain a variety of settings, including output functions associated with the different commands, which may be specific to the identified user. For example, User A may gain access to a user profile on a device by providing user identification data (e.g., a digital fingerprint, user-associated passcode, user credentials, biometric data, device data, etc.) to an input field on a login screen of the device. Subsequent to granting User A access to their user profile, an embodiment may have access to command input data associated with User A. If User B logs in to a user profile associated with User B on the same device, an embodiment may access command input data specific to User B rather than the command input data associated with User A. In such a situation, an event may occur where both User A and B provide the same command input (e.g., a finger wag, etc.), but the corresponding output function associated with the finger wag may be different for each user and may depend on the user who is providing the input.

Responsive to determining, at 303, that the user command input is associated with at least one function, an embodiment may perform, at 305, the at least one function. For purposes of discussion, the at least one function is a function related to a way output is performed or the way output is provided to a user. In an embodiment, the speech recognition device, or another device associated with the speech recognition device, may provide output to a user. The output may be audio output, visual output, a combination thereof, or the like. In an embodiment, the audible output may be provided through a speaker, another output device, and the like. In an embodiment, the visual output may be provided through a display screen, another display device, and the like. In an embodiment, the output device may be integral to the speech recognition device or may be located on another device. In the case of the latter, the output device may be connected via a wireless or wired connection to the speech recognition device. For example, a smart phone may provide instructions to provide audible output through an operatively coupled smart speaker.

In a situation where the user command input is received during the provision of output, an embodiment may adjust an output setting associated with the output based upon the user command input. In an embodiment, the output setting may correspond to an output speed and the performance of the at least one function may correspond to the adjustment of how fast the output is being provided to the user. For example, a user may be in a hurry and provide a user command to increase the speed of the output. An embodiment may then increase the rate at which output is provided to the user. The increase in rate may be a predetermined increase (e.g., 25% faster, etc.) or may be a rate specified by the user (e.g., “tell me that at double speed”, etc.).

In an embodiment, the output setting may correspond to an output length or an output summary and the performance of the at least one function may correspond to the adjustment of the length or type of the output provided to the user. For example, a user may be in a hurry and provide a user command to summarize the output. An embodiment may then summarize the output content (e.g., by utilizing automatic document summary techniques, etc.). The summarized version of the output may be provided to the user in lieu of the full output. Conversely, in another example, a user may want to know more information about the output and provide a command asking the digital assistant for more details (e.g., such as the rest of weather forecast, where there is a slowdown on a driving route, etc.). Although the aforementioned output summarization and output elaboration examples were explained using voice input commands, gestures may also be used to provide these commands. For example, a compress gesture (e.g., where a user moves two fingers or their hands together, etc.) may be used to command the digital assistant to summarize the output and a stretch gesture (e.g., where a user moves two fingers or their hands apart, etc.) may be used to command the digital assistant to provide additional details.

Responsive to not determining, at 303, that the user command input is associated with at least one function, an embodiment may assign, at 304, a function to the command input. In an embodiment, the assigning of the function may comprise querying a user to assign a function to the user command input. For example, an embodiment may audibly state that it does not recognize the user command input and may ask the user to assign a function to that input. Responsive to receiving a user's function assignment, an embodiment may store that assignment (e.g., in an accessible storage database, etc.) and thereafter perform the stored function upon receiving subsequent iterations of the same user command input. An embodiment may also learn the function based upon other information received from the user. For example, if the user is making a particular gesture and also providing audible input, the system may determine that the gesture should be associated with a function included in the audible input. As an example, a user may put a finger to their lips and also say “shhh”. An embodiment may then associate the finger to the lips gesture with a “stop providing output” function.

In an embodiment, all unrecognizable command inputs associated with a particular digital assistant application may be tagged and stored in a database. A function may thereafter be assigned to these command inputs by an application manager. Alternatively, an embodiment may receive crowdsourced input to determine an appropriate function of the received command input. For example, a plurality of users may identify that a particular gesture should be assigned to a particular function. An embodiment may then assign that function to the gesture. Responsive to receiving a function assignment, an embodiment may thereafter perform the function upon receiving subsequent iterations of the same user command input.

The various embodiments described herein thus represent a technical improvement to conventional digital assistant interaction techniques. Using the techniques described herein, an embodiment may receive an indication to engage in an interactive session with a digital assistant, during which time a user may provide user command input (e.g., voice input, gesture input, etc.) to the digital assistant. An embodiment may then determine a characteristic associated with the user command input and, based on the characteristic, whether the user command input is associated with a function. Responsive to determining that the command input is mapped to a function, an embodiment may perform the function. Such techniques enable a device to more naturally communicate with the user when processing user command input.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
engaging, at an information handling device, in an interactive session with a user;
receiving, at the information handling device, user command input comprising one or more of: voice input and gesture input;
determining, using a processor, whether the user command input is associated with at least one function, wherein the at least one function is based on a characteristic associated with the user command input; and
performing, during the interactive session, the at least one function.

2. The method of claim 1, wherein the receiving comprises receiving the user command input during provision of output by the information handling device.

3. The method of claim 2, wherein the performing the at least one function comprises adjusting an output setting associated with the output based upon the user command input.

4. The method of claim 3, wherein the output setting comprises an output speed and wherein the adjusting comprises adjusting the output speed of the output.

5. The method of claim 1, wherein the characteristic associated with the user command input comprises a user providing the user command input.

6. The method of claim 1, wherein the characteristic associated with the user command input comprises a context associated with the user command input.

7. The method of claim 1, responsive to determining that the user command input is not associated with the at least one function, querying a user to assign a function to the user command input and performing the assigned function upon subsequently receiving the user command input.

8. The method of claim 1, responsive to determining that the user command input is not associated with the at least one function, assigning a function to the user command input.

9. The method of claim 8, wherein the assigning comprises assigning based upon one or more of: crowdsourced input, input from another user, and a function associated with another user command input provided substantially simultaneously with the user command input.

10. The method of claim 1, wherein the determining comprises identifying the at least one function in the user command input associated with voice input provided substantially simultaneously with user command input associated with gesture input and thereafter assigning the at least one function in the user command input associated with voice input to the user command input associated with gesture input.

11. An information handling device, comprising:
a processor;
a memory device that stores instructions executable by the processor to:
engage in an interactive session with a user;
receive user command input comprising one or more of: voice input and gesture input;
determine whether the user command input is associated with at least one function, wherein the at least one function is based on a characteristic associated with the user command input; and
perform, during the interactive session, the at least one function.

12. The information handling device of claim 11, wherein the instructions executable by the processor to receive comprise instructions executable by the processor to receive the user command during provision of output by the information handling device.

13. The information handling device of claim 12, wherein the instructions executable by the processor to perform the at least one function comprise instructions executable by the processor to adjust an output setting associated with the output based upon the user command input.

14. The information handling device of claim 13, wherein the output setting comprises an output speed and wherein the instructions executable by the processor to adjust comprise instructions executable by the processor to adjust the output speed of the output.

15. The information handling device of claim 11, wherein the characteristic associated with the user command input comprises a user providing the user command input.

16. The information handling device of claim 11, wherein the characteristic associated with the user command input comprises a context associated with the user command input.

17. The information handling device of claim 11, wherein the instructions are further executable by the processor to query, responsive to determining that the user command input is not associated with the at least one function, a user to assign a function to the user command input.

18. The information handling device of claim 17, wherein the instructions are further executable by the processor to perform the assigned function upon subsequently receiving the user command input.

19. The information handling device of claim 11, wherein the instructions are further executable by the processor to assign, responsive to determining that the user command input is not associated with the at least one function, a function to the user command input.

20. A product, comprising:
a storage device that stores code, the code being executable by a processor and comprising:
code that engages in an interactive session with a user;
code that receives user command input comprising one or more of: voice input and gesture input;
code that determines whether the user command input is associated with at least one function, wherein the at least one function is based on a characteristic associated with the user command input; and
code that performs, during the interactive session, the at least one function.
